(19) United States
(12) Patent Application Publication
(10) Pub. No.: US 2002/0078099 A1
(43) Pub. Date: Jun. 20, 2002

(54) Method and system for off-loading and retrieving document content in a document processing system

(75) Inventors: Matthias Stefan Bierbrauer, Stuttgart (DE); Daniel Haenle, Stuttgart (DE)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY

(21) Appl. No.: 10/015,472

(22) Filed: Dec. 12, 2001

(30) Foreign Application Priority Data
Dec. 15, 2000 (EP) 00127580.9

(51) Int. Cl. G06F 15/00

(52) U.S. Cl. 707/522

(57) ABSTRACT

A technique for handling off-loading and retrieval of document content in a document processing system like Lotus Notes or Microsoft Exchange is disclosed. Content is detached from a document and off-loaded to a repository. The off-loaded content is replaced in the document by a text message which explains that the content has been off-loaded and a labelled retrieve button. Code is provided relative to the button to retrieve the content back from the repository when a user selects the button for reincorporation into the document. When the content has been restored to the document, the text message and the retrieve button are removed from the document. Since the whole code is kept behind the button, there is no need to modify the document processing application. This means an existing application built on top of a document processing system can be enabled for off-loading with few administrative steps.

### RELATED INVENTIONS

IBM patent application Ser. No. ______, entitled “Method and System for Automized and Synchronous Execution of Customized Code on Off-Loaded Retrieved Documents in a Document Processing System”, filed concurrently herewith on Dec. 12, 2001 and IBM application Ser. No. ______, entitled “Technique for Content Off-Loading in a Document Processing System using Stub Documents”, filed concurrently herewith on Dec. 12, 2001, are related to this invention.

### BACKGROUND OF THE INVENTION

1. Field of the Invention

The invention relates to data processing environments with large document repositories. More specifically, the present invention relates a technique for off-loading the contents of a document located on a document processing system to a remote repository.

2. Description of the Related Art

Known client mailing applications like Lotus™ Notes™ or Microsoft™ Outlook™ contain continuously growing document repositories, namely the incoming and outgoing notes or emails, which will generally be referred to as documents hereafter. These documents often including large attachments such as text (word processor) documents, graphics storage-consuming digitized pictures, etc. Therefore, the problem of document repositories that become too large must be dealt with. Lotus Notes uses a Lotus Domino™ database from which a tool like IBM Content Manager CommonStore™ for Lotus Domino (CSLD) is used to move documents stored in that database to an archive physically located on a different device, such as a tape storage. CSLD allows users to access documents that have previously been archived via Lotus Notes. Lotus, Notes, Domino and CommonStore are trademarks or registered trademarks of Lotus Development Corporation and/or International Business Machines (IBM) Corp.; Microsoft and Outlook are trademarks of Microsoft Corp.

CSLD also allows access to documents that have been archived from any archive client application e.g., scanning applications, CommonStore for SAP™, etc. When such documents are retrieved from the archive to a Notes database, a Lotus Notes document is created. SAP is a trademark of SAP AG.

When content has been off-loaded from a document resident in a document processing system, it must somehow be communicated to a user of the system that content has been off-loaded from the document when the user views the diminished version of the document. Also, a user must be able to retrieve the off-loaded content in such a way that the document including the restored content looks as it did before the content was off-loaded.

However, to enable content retrieval, modifications must be made to an application built on top of the document processing system, e.g., in case of Lotus Notes, in the form of a template. Implementing these modifications is rather time consuming and cost extensive.

### SUMMARY OF THE INVENTION

Therefore, an object of the present invention is to provide a technique for handling off-loading of content to a large document repository in a manner that enables retrieval of off-loaded content without requiring modification of a document processing application.

Another object of the invention is to provide a technique that enables user-friendly handling of off-loading and retrieval of document content.

The underlying concept is to detach content from a document and to off-load the detached content to a repository. The off-loaded content is replaced in the document by a text message that the content has been off-loaded and a labelled retrieve button. The message and button are displayed to the user via the mail application when the user views the partial document which remains on the mail application. Code is provided relative to the button to retrieve the content back from the repository upon selection of the button by the user.

When previously off-loaded content has been restored, the text message and the retrieve button are removed. Since the code is kept behind the button, there is no need to modify the document processing application. This means an existing application built on top of a document processing system can be enabled for off-loading with a few administrative steps.

Preferably, the above mentioned remote repository server is physically located on a different device, such as a local hard disk.

### BRIEF DESCRIPTION OF THE DRAWINGS

In the following, the present invention is described in more detail by way of embodiments from which further features and advantages of the invention become evident whereby:

FIG. 1 shows the scenario for off-loading a mail attachment and replacing it with a button to retrieve the off-loaded content;

FIG. 2 shows the scenario for retrieving off-loaded content and restoring the original attachment; and

FIG. 3 shows a detailed data flow diagram illustrating the various steps involved with invoking a request to to retrieve a document in the case of IBM Content Manager CommonStore for Lotus Domino (CSLD).

### DESCRIPTION OF THE PREFERRED EMBODIMENT

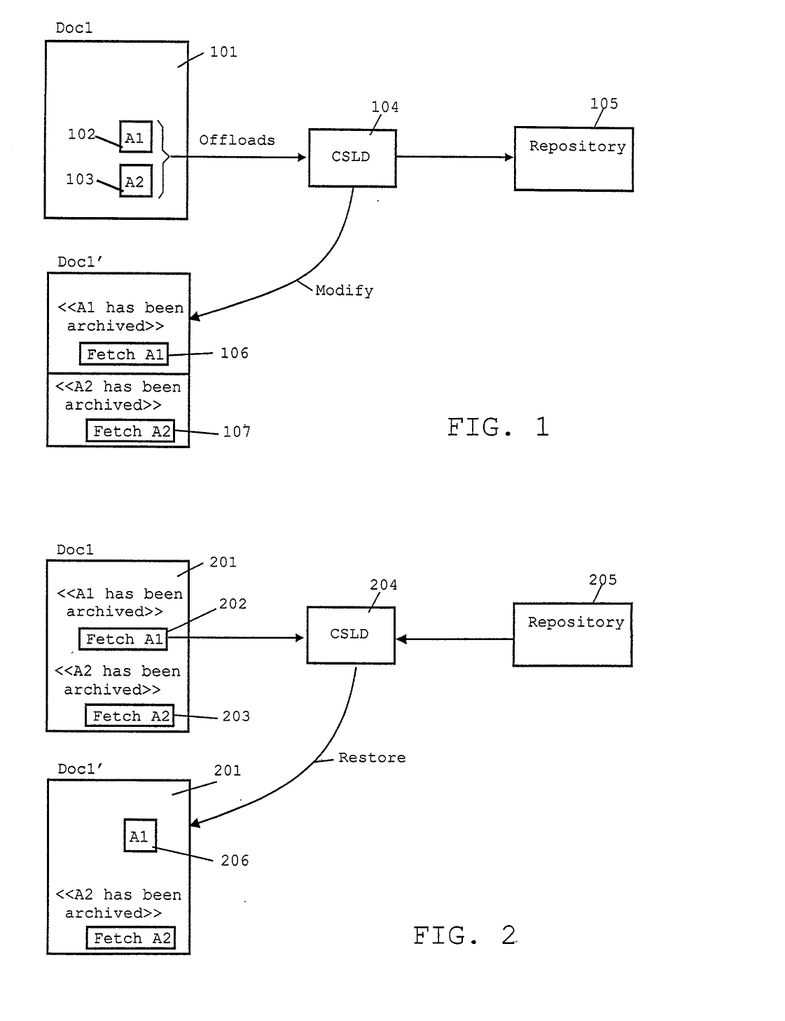

FIG. 1 exemplary shows a Lotus Notes document 101 containing two attachments 102, 103 (A1, A2). It is readily understood hereby that the document 101 can be a document of any document processing system where content of a document can be off-loaded to free-up resources.

IBM Content Manager CommonStore for Lotus Domino (CSLD) 104 off-loads the attachments 102, 103 to a repository 105. CSLD 104 detaches the attachments 102, 103 and replaces them by placeholder texts and retrieve buttons 106, 107, respectively. In this embodiment, the retrieve buttons 106, 107 are labelled after the names of the original attachment in order to associate buttons with attachments. The retrieve buttons 106, 107 are part of the document body, thus do not require any customization of the processing application.

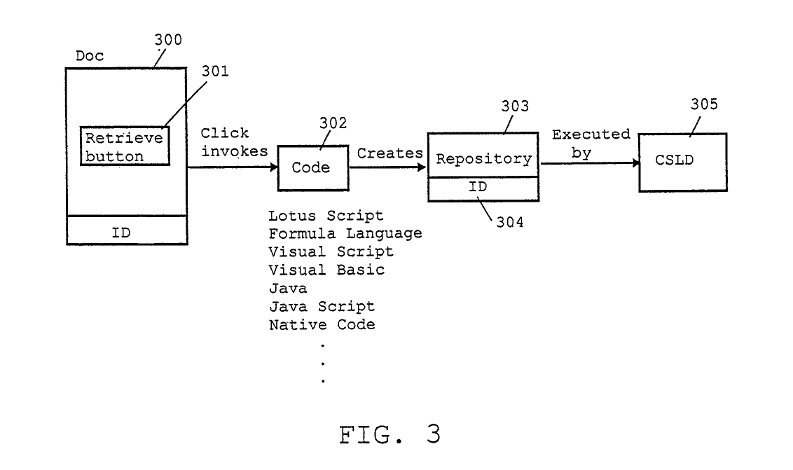

FIG. 2 exemplarily shows a Lotus Notes document (doc1) 201 after attachment off-loading. It contains placeholder text and retrieve buttons 202, 203 for two attachments. By pushing button 202, a user invokes CSLD 204 to retrieve the according content back from the repository 205. CSLD restores attachment (A1) 206 back to the Notes document (doc1) 201 thereby removing the placeholder text and the retrieve button.

It is understood hereby that the above scenarios are only exemplary and not limited to attachment off-loading. Alternatively, whole documents or any part of a document can be off-loaded as well, using the invention. The aforedescribed retrieve button is also only exemplary and can be realized by any other design or Graphical User Interface (GUI) element like an image, icon, clickable text or area, or the like. In case of Lotus Notes it is a button hotspot richtext element.

When content is off-loaded by CSLD, it is assigned a unique identifier (ID) 304. In the present example, this ID 304 is stored in the document 300 that contained the off-loaded content. As shown in FIG. 3, the labelled button 301, in the case of CSLD, invokes LotusScript code 302 that issues a retrieve request 303 to CSLD. The retrieve request 303 contains the ID 304 of the content to be retrieved and the target document in which the content is to be restored.

The exact nature of the code executed by selecting the button depends on the underlying document processing system. In case of Microsoft Exchange, code written in Visual Basic could be invoked. Other possible solution can be Java, JavaScript, or any programming language which enables invocation of executable code from within a document.

1. A method for handling off-loading and retrieval of document content in a document processing system, said method comprising the steps of:
detaching content from a document;
transferring the detached content to a repository; and
replacing the transferred content with a placeholder text message stating that the detached content has been transferred, and a retrieve button having is executable code associated therewith that enables retrieval of the detached content from the repository when the button is selected.

2. The method according to claim 1, wherein the text message is included in the document.

3. The method according to claim 1, wherein the button is presented to a user via a graphical interface of a document processing application.

4. The method according to claim 1, wherein the button is inserted in the document.

5. The method according to claim 1, wherein further comprising the step of removing the placeholder text message and the button from the document when the detached content is restored from the repository to the document.

6. A system for handling off-loading and retrieval of document content in a document processing system, comprising:
means for detaching content from a document;
means for transferring the detached content to a repository; and
means for replacing the detached content in the document with a placeholder text message indicating that the detached content has been transferred to the repository and may be retrieved, and a retrieve button associated with executable code that enables retrieval of the detached content back from the repository upon selection of the button.

7. The system according to claim 6, wherein the document processing system includes a graphical interface which presents the button.

8. The system according to claim 6, further comprising means for inserting the button in the document.

9. The system according to claims 6, further comprising means for removing the placeholder text message and the button when the detached content is retrieved from the repository.

10. Computer-readable code for execution in a data processing system comprising software code portions for handling off-loading and retrieval of document content in a document processing system, said code comprising:
first subprocesses for detaching content from a document;
second subprocesses for transferring the detached content to a repository; and
third subprocessess for replacing the transferred content with a placeholder text message stating that the detached content has been transfered, and a retrieve button having is executable code associated therewith that enables retrieval of the detached content back from the repository when the button is selected.
